(19) United States
(12) Patent Application Publication
(10) Pub. No.: US 2022/0337020 A1
(43) Pub. Date: Oct. 20, 2022

(54) OPTICAL AMPLIFIER

(71) Applicant: NIPPON TELEGRAPH AND TELEPHONE CORPORATION, Tokyo (JP)

(72) Inventors: Shinichi AOZASA, Musashino-shi, Tokyo (JP); Taiji SAKAMOTO, Musashino-shi, Tokyo (JP); Kazuhide NAKAJIMA, Musashino-shi, Tokyo (JP); Masaki WADA, Musashino-shi, Tokyo (JP)

(73) Assignee: NIPPON TELEGRAPH AND TELEPHONE CORPORATION, Tokyo (JP)

(21) Appl. No.: 17/760,713

(22) PCT Filed: Sep. 26, 2019
(86) PCT No.: PCT/JP2019/037910

§ 371 Date: Mar. 15, 2022

(51) Int. Cl. H01S 3/094; H01S 3/067; H01S 3/16

(52) U.S. Cl. CPC H01S 3/094007; H01S 3/06716; H01S 3/1608

(57) ABSTRACT

An object is to provide an optical amplifier with a cladding pumped configuration that improves amplification efficiency. The optical amplifier according to the present invention includes a pump light conversion fiber 11 that converts first pump light L1 with a first wavelength propagating in a cladding into second pump light L2 with a second wavelength, an amplification fiber 13 that is connected to the pump light conversion fiber 11 and optically amplifies signal light Ls with the second pump light L2 supplied to the cladding from the pump light conversion fiber 11, and an oscillator 12 that causes the second pump light L2 to be reflected on two reflectors 15 and to reciprocate within the claddings of the pump light conversion fiber 11 and the amplification fiber 13 to cause laser oscillation of the second pump light L2.

### TECHNICAL FIELD

The present disclosure relates to an optical amplifier disposed in an optical communication system in which spatially multiplexing (multi-core or multi-mode) optical fibers are used.

### BACKGROUND ART

Optical amplifiers for amplifying an optical signal as it is without converting the optical signal into an electric signal in an optical communication system with single-mode optical fibers have been put into practical use. Spatially multiplexing optical amplifiers are also expected to be able to be used for optical communication systems using spatially multiplexing optical fibers (see, e.g., NPL 1).

A configuration in which pump light beams are individually supplied to the cores for amplification (a core pumped configuration) and a configuration in which pump light beams are supplied to the cladding (a cladding pumped configuration) are known as configurations of spatially multiplexing optical amplifiers. The cladding pumped configuration can allow a plurality of spatial channels propagating within the cladding to be simultaneously amplified and can be simplified compared to the core pumped configuration. Furthermore, the cladding pumped configuration is expected to reduce power consumption compared to a configuration in which the same number of optical amplifiers for core pumping as that of spatial channels are used (for example, see NPL 2). In addition, regarding the cladding pumped configuration, a multi-mode laser diode (LD) can be used as a light source and thus photoelectric conversion efficiency can be improved compared to a core pumped configuration in which a single-mode LD needs to be used as a light source.

### CITATION LIST

### Non Patent Literature

NPL 1: M. Wada et al., “Recent Progress on SDM Amplifiers”, WelE. 3, Proc. ECOC, (2018).
NPL 2: S. Jain et al., “32-core Erbium/Ytterbium Doped Multi-Core Fiber Amplifier for Next Generation Space-Division Multiplexed Transmission System”, Optics Express, 25 (26), (2017).
NPL 3: K. S. Abedin et al., “Cladding-Pumped Erbium-Doped Multicore Fiber Amplifier”, Optics Express, 20 (18), (2012).

### SUMMARY OF THE INVENTION

### Technical Problem

However, there is a problem in that the cladding pumped configuration has inferior amplification efficiency to that of the core pumped configuration because, among pump light, light that is incident on the cladding but is not coupled to the cores is not used in amplification of optical signals. For example, in the 6-core EDTA of NPL 3, when the pump light is 10.6 W, the signal light output intensity is 32 mW per core, and thus the light conversion efficiency is only approximately 2%.

Therefore, in order to solve the problem described above, an object of the present invention is to provide an optical amplifier having a cladding pumped configuration that improves amplification efficiency.

### Means for Solving the Problem

In order to achieve the object described above, an optical amplifier according to the present invention converts a wavelength of pump light from a light source coupled to a cladding and causes laser oscillation of the pump light.

Specifically a first optical amplifier according to the present invention includes a pump light conversion fiber configured to convert first pump light with a first wavelength propagating in a cladding into second pump light with a second wavelength, an amplification fiber connected to the pump light conversion fiber, the amplification fiber being configured to optically amplify signal light with the second pump light supplied to a cladding from the pump light conversion fiber, and

an oscillator configured to cause the second pump light to be reflected on two reflectors and to reciprocate within the claddings of the pump light conversion fiber and the amplification fiber to cause laser oscillation of the second pump light.

The present optical amplifier converts the wavelength of the pump light in the cladding propagating in multiple modes, causes laser oscillation of the pump light in a section including the amplification fiber, and enhances the optical intensity of the pump light. Therefore, the present optical amplifier can amplify the signal light with the pump light having a stronger optical intensity and improve amplification efficiency compared to a typical cladding pumped configuration.

Thus, the present invention can provide the optical amplifier with the cladding pumped configuration that improves the amplification efficiency.

In addition, a second optical amplifier according to the present invention includes an amplification fiber configured to convert first pump light with a first wavelength propagating in a cladding into second pump light with a second wavelength and to optically amplify signal light with the second pump light within the cladding, and an oscillator configured to cause the second pump light to be reflected on two reflectors and to reciprocate within the cladding of the amplification fiber to cause laser oscillation of the second pump light.

The present optical amplifier converts the wavelength of the pump light in the cladding propagating in multiple modes in the amplification fiber, causes laser oscillation of the pump light in the amplification fiber, and enhances the optical intensity of the pump light. Therefore, the present optical amplifier can amplify the signal light with the pump light having a stronger optical intensity and improve amplification efficiency compared to a typical cladding pumped configuration. Further, the present optical amplifier is simpler in structure than the first optical amplifier.

Thus, the present invention can provide the optical amplifier with the cladding pumped configuration that improves the amplification efficiency.

The cladding of the amplification fiber of the second optical amplifier according to the present invention may have a first cladding region around a core and a second cladding region covering the first cladding region, and the first cladding region may convert the first pump light into the second pump light. The propagation mode of the second pump light within the amplification fiber can be limited and the optical amplification of the signal light can be stabilized.

The amplification fiber of the second optical amplifier according to the present invention may be a multi-core fiber or a multi-mode fiber.

Note that each of the inventions described above can be combined with each other to the extent possible.

### Effects of the Invention

The present invention can provide an optical amplifier with the cladding pumped configuration that improves amplification efficiency.

### BRIEF DESCRIPTION OF DRAWINGS

FIG. 1 is a diagram illustrating an optical amplifier according to the present invention.

FIG. 2 is a diagram illustrating another optical amplifier according to the present invention.

FIG. 3 is a diagram for describing an amplification fiber of the optical amplifier according to the present invention. FIG. 3(A) is a cross-sectional structure of a pump light conversion fiber, and FIG. 3(B) is a diagram for describing a refractive index or a rare earth concentration distribution.

FIG. 4 is a diagram for describing another amplification fiber of the optical amplifier according to the present invention. FIG. 4(A) is a cross-sectional structure of a pump light conversion fiber, and FIG. 4(B) is a diagram for describing a refractive index or a rare earth concentration distribution.

### DESCRIPTION OF EMBODIMENTS

Embodiments of the present invention will be described with reference to the accompanying drawings. The embodiments described below are examples of the present invention and the present invention is not limited to the embodiments described below. Note that constituent components with the same reference signs in the specification and the drawings are assumed to be the same.

### First Embodiment

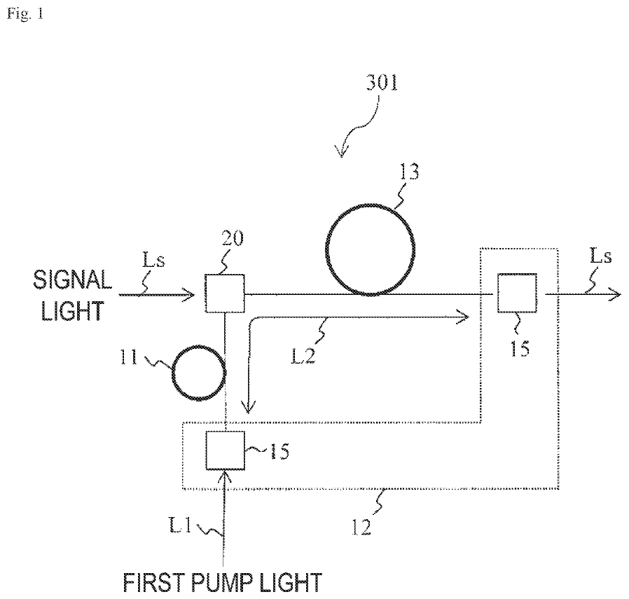

FIG. 1 is a diagram illustrating an optical amplifier 301 according to lire present embodiment. The optical amplifier 301 includes

a pump light conversion fiber 11 that converts first pump light L1 with a first wavelength propagating in a cladding into second pump light L2 with a second wavelength,
an amplification fiber 13 that is connected to the pump light conversion fiber 11 and optically amplifies signal light Ls with the second pump light L2 supplied to a cladding from the pump light conversion fiber 11, and
an oscillator 12 that causes the second pump light L2 to be reflected on two reflectors 15 and to reciprocate within the claddings of the pump light conversion fiber 11 and the amplification fiber 13 to cause laser oscillation of the second pump light L2.

The optical amplifier 301 is constituted by a light source (not illustrated) that generates the first pump light L1, a multiplexer 20 that multiplexes the signal light Ls and the first pump light L1, a pump light conversion fiber H that absorbs the first pump light L1 and generates the second pump light L2 with a different wavelength, an amplification fiber that is disposed in a subsequent part of the multiplexer 20 and optically amplifies the signal light Ls, and the oscillator 12 including the two reflectors 15 disposed in a preceding part of the pump light conversion fiber 11 and in a subsequent part of the amplification fiber 13 to cause the second pump light L2 to resonate.

The amplification fiber 13 is, for example, an erbium-doped multi-core fiber (EDF). The pump light conversion fiber 11 is, for example, an ytterbium (Yb)-doped multi-mode fiber. Note that, although the amplification fiber 13 is described as a multi-core optical fiber in the present embodiment, the same also applies to a multi-mode optical fiber.

Note that the optical fibers of the optical amplifier according to the present invention are not limited by the types of ions to be doped. In addition, the pump light conversion fiber 1L the amplification fiber 13, and an optical fiber connecting the aforementioned fibers may have a solid type structure or a hole type structure such as a photonic crystal fiber bandgap fiber. Note that the pump light conversion fiber 11 has a two-stage cladding structure so as to allow the first pump light L1 to propagate within the cladding. Furthermore, from the perspective of connection loss, the pump light conversion fiber 11 is preferably of the same type as a multi-mode fiber that allows the first pump light L1 to propagate from the light source to the pump light conversion fiber 11.

The light source is a multi-mode LD that outputs the first pump light L1 (e.g., with a wavelength of 0.92 μm) in multiple modes. The pump light conversion fiber 11 absorbs the first pump light L1 and converts it into light with a different wavelength (e.g., a wavelength of 0.98 μm). The multiplexer 20 multiplexes light (the second pump light L2) the wavelength of which has been converted by the pump light conversion fiber 11 with the signal light Ls and causes the multiplexed light to be incident on the amplification fiber 13. The light (the second pump light L2) the wavelength of which has been converted by the pump light conversion fiber 11 is incident on the cladding of the amplification fiber 13, and the signal light Ls is incident on each core of the amplification fiber 13.

The reflectors 15 of the optical amplifier 301 are disposed in a preceding part of the pump light conversion fiber 11 and in a subsequent part of the amplification fiber 13 and cause laser oscillation of the light the wavelength of which has been converted by the pump light conversion fiber 11 within the claddings of the pump light conversion fiber 11 and the amplification fiber 13 to generate the second pump light L2. The reflectors 15 are achieved by forming a Bragg grating or a spatial filter that reflects only light with a specific wavelength within the claddings of the optical fibers. Note that, because the signal light Ls propagates through the core of the amplification fiber 13, it passes through the reflector 15 and is output.

Because the second pump light L2 reciprocates between the reflectors 15 and thus is reused many times for amplification by the amplification fiber 13, the amplification efficiency of the amplification fiber 13 is improved. The optical amplifier 301 can increase the amplification efficiency by using light from the multi-mode LD, which is a light source with good photoelectric conversion efficiency, for amplification many times as described above.

Accordingly, the optical amplifier 301 having the cladding pumped configuration can improve amplification efficiency.

### Second Embodiment

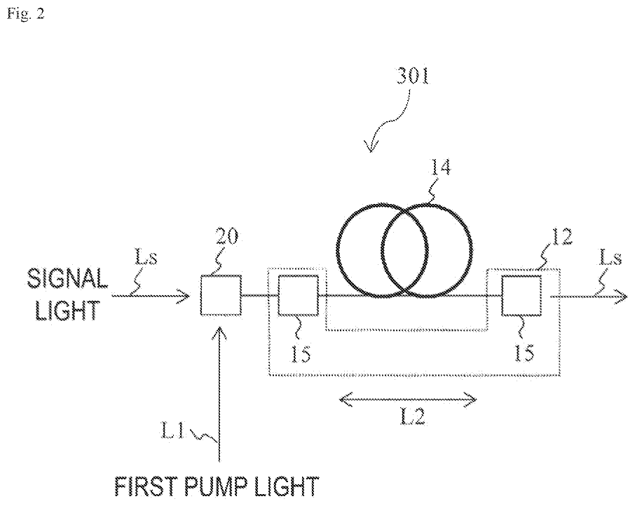

FIG. 2 is a diagram illustrating an optical amplifier 302 according to the present embodiment. The optical amplifier 302 includes

an amplification fiber 14 that converts first pump light L1 with a first wavelength propagating through a cladding into second pump light L2 with a second wavelength and optically amplifies signal light with the second pump light L2 within the cladding, and
an oscillator 12 that causes the second pump light L2 to be reflected on two reflectors 15 and to reciprocate within the cladding of the amplification fiber 14 to cause laser oscillation of the second pump light L2.

The optical amplifier 301 includes a multiplexer 20 that multiplexes signal light Ls with the first pump light L1, a light source (not illustrated) that generates the first pump light L1, the amplification fiber 14 that absorbs the first pump light L1 to generate pump light L2 with a different wavelength and amplify the signal light Ls with the second pump light L2, and the two reflectors 15 disposed in subsequent and preceding parts of the signal fiber 14 to cause the pump light L2 to resonate.

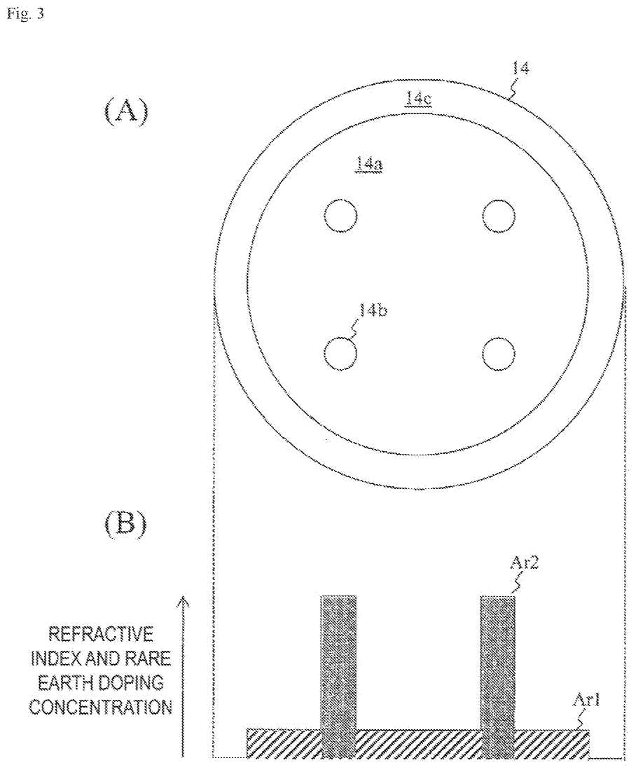

The amplification fiber 14 is a multi-core fiber doped with rare earth ions. The rare earth elements are, for example, erbium (Er) and ytterbium (Yb). Note that optical fibers of the optical amplifier according to the present invention are not limited by the types of ions to be doped. FIG. 3(A) is a diagram for describing a cross section of the amplification fiber 14, 14a represents a cladding, 14b represents a core, and 14c represents a coaling (a second cladding). The amplification fiber 14 has a two-stage cladding structure so as to allow the second pump light L2 to propagate within the cladding. FIG. 3(B) is a diagram for describing a concentration distribution of rare earth ions of the amplification fiber 14. The horizontal axis represents a radial position and the vertical axis represents a concentration of each type of ion. Ar1 indicates the region doped with Yb ions and its concentration, and Art indicates an Er ion concentration or the region doped with Er and Yb ions and its concentration.

Note that, although the amplification fiber is described as a multi-core optical fiber in the present embodiment, the same also applies to a multi-mode optical fiber. In addition, the amplification fiber 14 and an optical fiber connecting them may have a solid type structure or a hole type structure such as a photonic crystal fiber bandgap fiber. Furthermore, the optical fiber from the light source to the amplification fiber 14 is a multi-mode fiber.

The light source is the same as that of the optical amplifier 301 described in the first embodiment. The multiplexer 20 multiplexes light from the light source (the first pump light L1) with the signal light Ls and causes the resulting light to be incident on the amplification fiber 14. The light from the light source (the first pump light L1) is incident on the cladding of the amplification fiber 14, and the signal light Ls is incident on each core of the amplification fiber 14. The amplification fiber 14 absorbs the first pump light L1 and converts it into light with a different wavelength (e.g., a wavelength of 0.98 μm).

The reflectors 15 of the optical amplifier 302 are disposed at both ends of the amplification fiber 14 and cause laser oscillation of light obtained by converting the wavelength of the first pump light L1 within the cladding of the amplification fiber 14 to generate the second pump light L2. The reflectors 15 are the same as the reflectors of the optical amplifier 301 described in the first embodiment.

The second pump light L2 is reused for amplification by the amplification fiber 13 many times by reciprocating between the reflectors 15 to improve the amplification efficiency of the amplification fiber 13. This is the same as in the description of the optical amplifier 301 in the first embodiment. Thus, the optical amplifier 302 having the cladding pumped configuration can improve amplification efficiency as well. In addition, the optical amplifier 302 can simplify the configuration of the amplifier because the amplification fiber 14 includes the functions of the pump light conversion fiber 11 and the amplification fiber 13 of the optical amplifier 301.

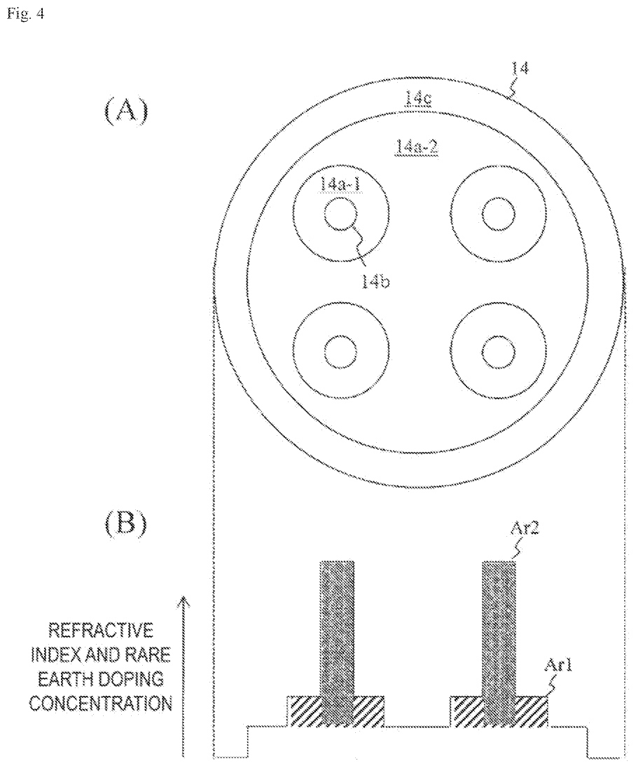

FIG. 4 is a diagram for describing another embodiment of the amplification fiber 14. The amplification fiber 14 of the present embodiment has characteristics that the cladding has first cladding regions 14a-1 around cores 14b and a second cladding region 14a-2 covering the first cladding regions 14a-1, and the first cladding regions 14a-1 convert first pump light L1 into second pump light L2.

The amplification fiber 14 of the present embodiment has cladding regions divided into the first cladding regions 14a-1 and the second cladding region 14a-2 compared to the amplification fiber 14 of FIG. 3, and Yb ions are doped only into the first cladding regions 14a-1. By configuring the amplification fiber 14 as described above, the first pump light L1 coupled to the cladding of the amplification fiber 14 is wavelength-converted only at the portion around each core 14b (the first cladding region 14a-1), and the second pump light L2 is obtained by the oscillator 12. The number of propagation modes in which the second pump light L2 can propagate within the amplification fiber 14 is limited. The optical amplifier 302 including the amplification fiber 14 of FIG. 4 can stabilize an amplification rate of optical amplification by limiting the number of propagation modes of the second pump light L2, compared to the optical amplifier 302 including the amplification fiber 14 of FIG. 3.

### Additional Description

The following describes the optical amplifier according to the present embodiment.

(1) The present optical amplifier including
a signal light amplification unit including a signal light amplification fiber having a function of converting a wavelength of first pump light incident from the outside into second pump light with a different wavelength and reflecting units that reflect the second pump light,
a signal light multiplexer for causing signal light to be incident on the signal light amplification unit, and
a pump light source that generates the first pump light to be incident on the signal light amplification unit.
(2) The optical amplifier of (1) described above, wherein
the signal light amplification unit includes a core having a signal light amplification function, a cladding doped with an element having a wavelength conversion function, and pump light reflecting units at both ends.
(3) The optical amplifier of (2) described above, wherein
the cladding includes a first cladding in which a cladding region having a wavelength conversion function is limited to the vicinity of the core and a second cladding in which pump light propagates.
(4) The optical amplifier of (1) to (3) described above, wherein
the signal light amplification fiber is an erbium-doped fiber optical amplifier.
(5) The optical amplifier of (1) to (4) described above, wherein the wavelength conversion unit or an element having a wavelength conversion function doped into the cladding is an optical fiber doped with ytterbium.
(6) The optical amplifier of (1) to (5) described above, wherein
the reflectors are fiber Bragg gratings.
(7) The optical amplifier of (1) to (6) described above, wherein
a wavelength of the first pump light is 900 to 960 nm, and a wavelength of the second pump light is 965 to 1010 mil.

The present optical amplifier has the following effects and features.

The present optical amplifier can efficiently supply cladding pump light propagating in multiple modes to the signal light amplification fiber using wavelength conversion and the reflectors. Further, by devising the configuration of the fiber for generating second pump light, the configuration of the amplifier can be simplified.
The present invention can provide a highly efficient optical amplifier and achieve large-capacity transmission over a long distance with low power consumption compared to conventionally used optical amplification techniques.

### REFERENCE SIGNS LIST

11 Wavelength conversion fiber
12 Oscillator
13, 14 Amplification fiber
14a Cladding
14a-1 First cladding region
14a-2 Second cladding region
14b Core
14c Coating
15 Reflector
20 Multiplexer
301 to 302 Optical amplifier

1. An optical amplifier comprising:
a pump light conversion fiber configured to convert first pump light with a first wavelength propagating in a cladding into second pump light with a second wavelength;
an amplification fiber connected to the pump light conversion fiber, the amplification fiber being configured to optically amplify signal light with the second pump light supplied to a cladding from the pump light conversion fiber; and
an oscillator configured to cause the second pump light to be reflected on two reflectors and to reciprocate within the claddings of the pump light conversion fiber and the amplification fiber to cause laser oscillation of the second pump light.

2. An optical amplifier comprising:
an amplification fiber configured to convert first pump light with a first wavelength propagating in a cladding into second pump light with a second wavelength and to optically amplify signal light with the second pump light within the cladding; and
an oscillator configured to cause the second pump light to be reflected on two reflectors and to reciprocate within the cladding of the amplification fiber to cause laser oscillation of the second pump light.

3. The optical amplifier according to claim 2, wherein
the cladding of the amplification fiber includes a first cladding region around a core and a second cladding region covering the first cladding region, and
the first cladding region converts the first pump light to the second pump light.

4. The optical amplifier according to claim 1, wherein
the amplification fiber is a multi-core fiber or a multi-mode fiber.
